(19) United States
(12) Patent Application Publication
(10) Pub. No.: US 2021/0081882 A1
(43) Pub. Date: Mar. 18, 2021

(54) SYSTEM AND METHOD FOR PROVIDING VEHICLE SUPPLY CHAIN AND LOGISTICS INFORMATION

(71) Applicant: Honda Motor Co., Ltd., Tokyo (JP)

(72) Inventors: Charles Franklin, Huntington Beach, CA (US); Michael A. Benitez, Irvine, CA (US); Kevin Hawkins, Yorba Linda, CA (US)

(21) Appl. No.: 17/019,871

(22) Filed: Sep. 14, 2020

Related U.S. Application Data
(60) Provisional application No. 62/901,200, filed on Sep. 16, 2019.

(51) Int. Cl. G06Q 10/08

(52) U.S. Cl. CPC G06Q 10/087; G06Q 10/0833; G06Q 10/0832

(57) ABSTRACT

A system and method for providing vehicle supply chain and logistics information that include determining vehicle supply chain data that pertains to an end-to-end supply chain process of vehicles. The system and method also include determining vehicle logistics data that pertains to transportation of the vehicles that are within the end-to-end supply chain process. The system and method further include presenting at least one user interface that allows a stakeholder to determine information associated with at least one of: the vehicle supply chain data and the vehicle logistics data.

### CROSS-REFERENCE TO RELATED APPLICATION

This application claims priority to U.S. Provisional Application Ser. No. 62/901,200 filed on Sep. 16, 2019, which is expressly incorporated herein by reference.

### BACKGROUND

In many cases product manufacturers, retailers, and/or customers are interested in knowing the status of products within a supply chain to determine an estimated time of arrival of a particular product. In particular, automobile manufactures, automobile dealers, customers, transportation providers, and/or additional entities may want to know a particular real-time status of one or more vehicle types, vehicle models, and/or vehicles that are to be dispatched from a manufacturing plant, that are to be delivered to particular region, that are to be sent to particular port of entry, that are to be sent to particular distribution centers, that are to be sent to particular dealers, and the like.

Such data may provide the automobile manufactures, automobile dealers, customers, transportation providers, and/or additional entities a real time determination of vehicle inventory that may be available or maybe made available at one or more points in time. However, in many cases there are many different operators, carriers, and/or entities that may be involved in the supply chain process of vehicles. Accordingly, to understand a real-time status of vehicles may require multiple systems to be accessed, multiple credentials to be utilized, and multiple complex system rules and interfaces to be learned. This may pose to be a challenging barrier to determine particular real-time status of products within a supply chain process.

### BRIEF DESCRIPTION

According to one aspect, a computer-implemented method for providing vehicle supply chain and logistics information that includes determining vehicle supply chain data that pertains to an end-to-end supply chain process of vehicles. The computer-implemented method also includes determining vehicle logistics data that pertains to transportation of the vehicles that are within the end-to-end supply chain process. The computer-implemented method further includes presenting at least one user interface that allows a stakeholder to determine information associated with at least one of: the vehicle supply chain data and the vehicle logistics data.

According to another aspect, a system for providing vehicle supply chain and logistics information that includes a memory storing instructions when executed by a processor cause the processor to determine vehicle supply chain data that pertains to an end-to-end supply chain process of vehicles. The instructions also cause the processor to determine vehicle logistics data that pertains to transportation of the vehicles that are within the end-to-end supply chain process. The instructions further cause the processor to present at least one user interface that allows a stakeholder to determine information associated with at least one of: the vehicle supply chain data and the vehicle logistics data.

According to yet another aspect, a non-transitory computer readable storage medium storing instructions that when executed by a computer, which includes a processor perform a method that includes determining vehicle supply chain data that pertains to an end-to-end supply chain process of vehicles. The method also includes determining vehicle logistics data that pertains to transportation of the vehicles that are within the end-to-end supply chain process. The computer-implemented method further includes presenting at least one user interface that allows a stakeholder to determine information associated with at least one of: the vehicle supply chain data and the vehicle logistics data

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for providing supply chain vehicle logistics information according to an exemplary embodiment of the present disclosure;

FIG. 2A is an illustrative non-limiting example of a supply chain query user interface according to an exemplary embodiment of the present disclosure;

FIG. 2B is another illustrative non-limiting example of the supply chain query user interface according to an exemplary embodiment of the present disclosure;

FIG. 2C is an illustrative non-limiting example of an action drop down menu according to an exemplary embodiment of the present disclosure;

FIG. 2D is an illustrative non-limiting example of a vehicle logistics query user interface according to an exemplary embodiment of the present disclosure;

FIG. 2E is an illustrative non-limiting example of a vessel port of call list user interface according to an exemplary embodiment of the present disclosure;

FIG. 2F is an illustrative non-limiting example of a port of call detail user interface according to an exemplary embodiment of the present disclosure;

FIG. 2G is an illustrative non-limiting example of a dashboard user interface according to an exemplary embodiment of the present disclosure;

FIG. 2H is an illustrative non-limiting example of a vehicle heat map of the dashboard user interface according to an exemplary embodiment of the present disclosure;

FIG. 3 is a schematic overview of a plurality of modules of a vehicle supply chain and vehicle logistics information presentation application according to an exemplary embodiment of the present disclosure;

FIG. 4 is a process flow diagram of a method for initiating a query to obtain vehicle supply chain data and/or vehicle logistics data according to an exemplary embodiment of the present disclosure; and

FIG. 5 is a process flow diagram of a method for providing vehicle supply chain and logistics information according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,’ as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Media Oriented System Transport (MOST), Local Interconnect Network (LIN), among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different vehicle features which include various vehicle components, systems, and subsystems. The term “input device” includes, but it not limited to: push buttons, rotary knobs, and the like. The term “input device” additionally includes graphical input controls that take place within a user interface which may be displayed by various types of mechanisms such as software and hardware based controls, interfaces, or plug and play devices.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from vehicle components, systems, subsystems, and electronic devices. The term “output devices” includes, but is not limited to: display devices, and other devices for outputting information and functions.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

### I. System Overview

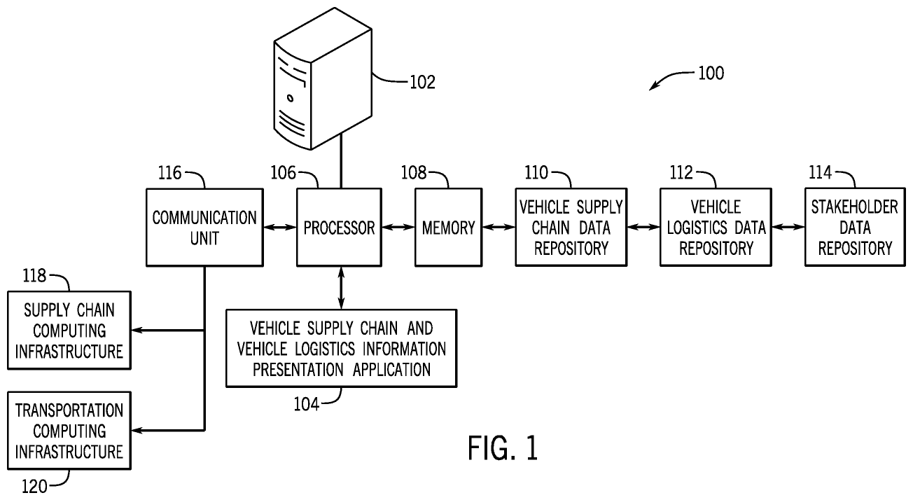

Referring now to the drawings, wherein the showings are for purposes of illustrating one or more exemplary embodiments and not for purposes of limiting the same, FIG. 1 is a schematic view of an exemplary operating environment 100 for providing vehicle logistics information according to an exemplary embodiment of the present disclosure. In an exemplary embodiment, the operating environment 100 may include a vehicle manufacturer server infrastructure (OEM server) 102 that may be configured to execute a vehicle supply chain and vehicle logistics information presentation application (vehicle SCL application) 104.

As discussed below, the vehicle SCL application 104 may be configured to present a human machine interface (HMI) that may include various user interfaces that may be presented to allow one or more stakeholders (not shown) to determine real-time supply chain information and real-time vehicle logistics information associated with a vehicle, a fleet of vehicles, vehicle parts, transportation of vehicles, and/or other types of inventory that may be manufactured by a vehicle manufacturer (OEM), one or more subsidiaries of the OEM, and/or one or more entities that may be associated with the OEM (e.g., third-party vehicle part manufacturers, retailers, distributors, etc.).

The one or more stakeholders may include, but may not be limited to, the OEM, subsidiaries of the OEM, third-party entities associated with the OEM, vehicle part manufacturers, supply chain parties, transportation providers, vehicle dealers, customers, retailers, vehicle customization entities, third-party vehicle mechanics/body shops/vehicle part retailers, shipping companies, shipping ports, airports, warehouse operators, freight handlers, airlines, freight haulers, train operators, trucking companies, third-party vehicle component/part manufacturers, and the like.

Based on the discretion of the OEM, one or more subsidiaries of the OEM and/or one or more entities that may be granted administrative privileges by the OEM or by one or more the subsidiaries, supply chain parties, and/or transportation providers, the vehicle SCL application 104 may be utilized by one or more particular stakeholders to determine vehicle supply chain information and/or vehicle logistics information. In particular, one or more of the stakeholders may be granted specific login and usage credentials that may be used to login to the vehicle SCL application 104 to determine the real-time supply chain information and/or real-time logistics information discussed above.

As discussed below, the vehicle SCL application 104 may be configured to present one or more query user interfaces that may enable one or more stakeholders to input a supply chain query to obtain vehicle supply chain information. The one or more query user interfaces may also enable one or more stakeholders to input a logistics query to obtain logistics information. Additionally, the one or more query user interfaces may enable the one or more stakeholders to input a combined query to obtain both supply chain information and logistics information simultaneously.

In one embodiment, the vehicle SCL application 104 may be configured to present vehicle supply chain information through one or more user interfaces (e.g., based on the receipt of a supply chain query or a combined query). The supply chain information may be derived from vehicle supply chain data that may be provided by one or more supply chain entities. As discussed in more detail below, the vehicle supply chain data may include end-to-end supply chain information associated with the location, status, inventory, and/or timing of one or more particular vehicles, one or more particular vehicle makes, one or more particular vehicle models, one or more particular vehicle configurations, one or more fleets of vehicles, one or more production lots of vehicles, vehicle parts associated with one or more vehicles, and the like.

In one embodiment, the vehicle SCL application 104 may also be configured to present vehicle logistics information through one or more user interfaces (e.g., based on the receipt of a logistics query or a combined query). The vehicle logistics information may be derived from vehicle logistics data that may be provided by one or more transportation entities (e.g., shipping companies, airlines, freight handlers, freight haulers, train operators, trucking companies, etc.).

The vehicle logistics data may pertain to one or more means of transportation that may be utilized to transport one or more vehicles that are in the supply chain process. For example, the vehicle logistics data may pertain to the locations of cargo ships, aircraft, trains, trucks, and/or other means of transportation that may be utilized to transport one or more particular vehicles, one or more particular vehicle makes, one or more particular vehicle models, one or more particular vehicle configurations, one or more fleets of vehicles, one or more production lots of vehicles, vehicle parts associated with one or more vehicles, and the like.

Accordingly, the vehicle SCL application 104 may be configured to provide and present one or more user interfaces to one or more of the stakeholders that may present vehicle supply chain data, the vehicle logistics data, or a combination of vehicle supply chain data and vehicle logistics data in one or more graphical formats. The one or more user interfaces may provide the stakeholder(s) with real-time information such as location information, status information, timing information, and/or inventory information that may pertain to one or more particular vehicles, one or more particular vehicle makes, one or more particular vehicle models, one or more particular vehicle configurations, one or more fleets of vehicles, one or more production lots of vehicles, vehicle parts associated with one or more vehicles, and the like. Additionally, location information, status information, timing information, and/or inventory information of one or more transportation providers may be efficiently provided to the stakeholder(s) though the one or more user interfaces.

With continued reference to the operating environment of FIG. 1, the OEM server 102 may include a processor 106. The processor 106 may operably control one or more components of the OEM server 102. In an exemplary embodiment, the processor 106 may be configured to execute the vehicle SCL application 104. The processor 106 may be configured to execute one or more operating systems, OEM system and subsystem executable instructions, and the like. The processor 106 may also include respective internal processing memory, an interface circuit, and bus lines for transferring data, sending commands, and communicating with the plurality of components of the OEM server 102.

In one embodiment, the processor 106 may be operably connected to a memory 108 of the OEM server 102. The memory 108 may be configured to store data files associated with one or more applications, operating systems, OEM systems, OEM system user interfaces, including, but not limited to data files of the vehicle SCL application 104. The memory 108 may be configured to store a vehicle supply chain data repository 110. The vehicle supply chain data repository 110 may be configured as a relational database that may be populated with vehicle supply chain data that is received through a communication unit 116 of the OEM server 102. Such vehicle supply chain data may be communicated from a supply chain computing infrastructure 118 (as discussed below) to be populated within the vehicle supply chain data repository 110.

The vehicle supply chain data may include particular details that may be provide one or more stakeholders with a real-time determination of a status of vehicles within the end-to-end supply chain process. For example, the vehicle supply chain data included within the vehicle supply chain data repository 110 may include information that may be associated with one or more types of vehicles that are moving through the supply chain process. Such information may include, but may not be limited to, the last registered location of one or more vehicles, the models of one or more vehicles, the vehicle identification numbers (VINs) of one or more types of vehicles, the production timeframe of one or more vehicles, the emission types of one or more vehicles, the carrier transporting one or more vehicles, the vessel transporting one or more vehicles, the aircraft transporting one or more vehicles, the port of departure/entry of one or more vehicles, the color/customization of one or more vehicles, the delivery status of one or more vehicles, and the like.

The supply chain data may also include real-time dealer inventory data that may pertain to a current inventory of one or more vehicles that may be retained by one or more vehicle dealers. In some embodiments, the vehicle supply chain data may pertain to end-to-end supply chain information pertaining to one or more particular vehicles from a point of manufacturing and delivery from the OEM to a transportation provider (e.g., train, aircraft, ship) through one or more intermediate locations (e.g., ports of exit, ports of entry) to a distribution center to a vehicle dealer to thereby be sold or leased to a customer. It is appreciated that the vehicle supply chain data may include additionally contemplated supply chain related information that may not be specifically disclosed herein. Accordingly, the supply chain data may be used to provide real-time supply chain information that may pertain to the aforementioned information and/or additionally contemplated information.

In one embodiment, the memory 108 may also be configured to store a vehicle logistics data repository 112. The vehicle logistics data repository 112 may be configured as a relational database that may be populated with vehicle logistics data that is received through the communication unit 116 of the OEM server 102. Such data may include real-time vehicle logistics data that is communicated from a transportation computing infrastructure 120 (as discussed below).

The vehicle logistics data may include particular details that may provide one or more stakeholders with a real-time status of GPS/DGPS real-time locations of one or more vessels and/or transportation vehicles (e.g., ships, aircraft, train, trucks) that are transporting one or more vehicles, the date/time of departure of one or more vessels and/or transportation vehicles that are transporting one or more vehicles, the estimated time of arrival to a particular destination (e.g., port, distribution center, warehouse, dealer, etc.) associated with one or more vessels and/or transportation vehicles, an estimated travel path associated with one or more vessels and/or transportation vehicles that are transporting one or more vehicles, and the like.

The vehicle logistics data included within the vehicle logistics data repository 112 may also include information that may be associated with estimated ports of call/airports/stations/delivery points of one or more vessels and/or transportation vehicles, future bookings associated with one or more vessels and/or transportation vehicles, and the like. It is appreciated that the vehicle logistics data may include additionally contemplated logistics related information that may not be specifically disclosed herein. Accordingly, the logistics data may provide a real-time vehicle logistics related information that may pertain to the aforementioned information and/or additionally contemplated information.

In an exemplary embodiment, the memory 108 of the OEM server 102 may additionally store a stakeholder data repository 114. The stakeholder data repository 114 may be configured as a relational database that may be populated based on data that is received through the communication unit 116 of the OEM server 102 by the OEM, one or more subsidiaries of the OEM and/or one or more entities that may be granted administrative privileges by the OEM or by one or more the subsidiaries. Such data may include stakeholder profile data that may include stakeholder information (e.g., name, address, identification number, financial transactional data) and specific login and usage credentials that may be used to login to the vehicle SCL application 104 and access one or more user interfaces that may present the real-time supply chain information and/or real-time logistics information that may be presented by the application 104.

In one or more embodiments, upon enablement and/or execution of the vehicle SCL application 104 through one or more computing devices (not shown) that may be used by one or more stakeholders, the vehicle SCL application 104 may present a login user interface that includes a login prompt that may be utilized by the stakeholder(s) to login and use the vehicle SCL application 104. Upon receiving an input of user credentials by the stakeholder(s) that vehicle SCL application 104 may be configured to access the stakeholder data repository 114 to query the stakeholder profile data to authenticate the stakeholder(s) to utilize the vehicle SCL application 104. Accordingly, the user credentials associated with each stakeholder may be used to access one or more user interfaces (discussed in detail below) of the vehicle SCL application 104 to selectively access vehicle supply chain information and/or vehicle logistics information as granted by the OEM, subsidiaries of the OEM, supply chain parties, and/or transportation providers.

In one embodiment, the stakeholder profile data associated with each stakeholder may be populated with a level of privileges that may be assigned to the respective stakeholder by the OEM, subsidiaries of the OEM, third-party entities associated with the OEM, supply chain parties, transportation providers, and the like. The level of privileges may include, but may not be limited to, a level of access privileges, a level of read privileges, a level of write privileges, a level of copy privileges, a level of print privileges, a level of forwarding privileges, and the like. In some configurations, the level of privileges may enable the respective stakeholder(s) to view one or more user interfaces that may present vehicle supply chain information, one or more user interfaces that may present vehicle logistics information, and/or one or more user interfaces that may present both vehicle supply chain information and vehicle logistics information.

Additionally, the level of privileges may enable the respective stakeholder(s) to view a level of access that may be associated with particular types of supply chain information and/or logistics information that may be viewed by the stakeholder(s) that pertain to one or more user interfaces that may present vehicle supply chain information, one or more user interfaces that may present vehicle logistics information, and/or one or more user interfaces that may present both vehicle supply chain information and vehicle logistics information. For example, the level of privileges may enable a level of access by the stakeholder(s) that may pertain to viewing a status of one or more vehicles at one or more ports, viewing a geo-location of a particular vessel by a particular shipping company, viewing data that may be deemed to be sensitive to the OEM, supply chain parties, and/or transportation providers.

With particular reference to the movement of the vehicles and associated components within the supply chain process, in one embodiment, at each step of the supply chain process, each vehicle, vehicle part associated with each vehicle, and/or other types of inventory that may be manufactured by a vehicle manufacturer (OEM) may be scanned in for confirmation of the supply chain step. The scanning may be utilized to input real-time information regarding the real-time status of the one or more particular vehicles, one or more particular vehicle makes, one or more particular vehicle models, one or more particular vehicle configurations, and the like in the supply chain process. In particular, the scanning may collect information about each vehicle, including but not limited to, a VIN of each vehicle, a make of the vehicle, a model of the vehicle, a body style of the vehicle, a configuration of the engine of the vehicle, a color of the vehicle, a distributor of the vehicle, a sale contact of the vehicle, a production date of the vehicle, a manufacturing facility of the vehicle, and the like.

Additionally, the scanning may collect information about the current location of the vehicle, any process that the vehicle is undergoing (e.g., waiting for train transport, waiting for approval for export, customization), an expected timeframe at the location and/or for the process to be completed, inventory information (e.g., part of dealership inventory), and the like. In some embodiments, with respect to one or more vehicle parts associated with each vehicle, and/or other types of inventory, the scanning may collect respective information, including but not limited to, a part number of each vehicle part, a serial number of each vehicle part, a model of each vehicle part, and the like.

In one embodiment, scanned data may be communicated directly to the supply chain computing infrastructure 118 as real-time vehicle supply chain data and populated within the vehicle supply chain data repository 110. In one configuration, the supply chain computing infrastructure 118 may be configured to include one or more externally hosted computing systems that may be owned, operated, and/or hosted by one or more supply chain parties. The supply chain computing infrastructure 118 may be accessed through the communication unit 116 of the OEM server 102 to obtain the vehicle supply chain data that is populated within the vehicle supply chain data repository 110.

In particular, as the stakeholder(s) utilizes one or more user interfaces of the vehicle SCL application 104 to query particular vehicle supply chain information, the vehicle SCL application 104 may utilize the communication unit 116 to access the vehicle supply chain data repository 110 and may further query the vehicle supply chain data repository 110 to retrieve the relevant vehicle supply chain data. The vehicle SCL application 104 may be configured to thereby present the relevant vehicle supply chain information that is derived from the relevant vehicle supply chain data via the user interface(s) of the application 104 to provide the stakeholder(s) with a real-time location, status, inventory, and/or timing information of one or more particular vehicles, one or more particular vehicle makes, one or more particular vehicle models, one or more particular vehicle configurations, one or more fleets of vehicles, one or more production lots of vehicles, vehicle parts associated with one or more vehicles, and the like, as requested by the stakeholder(s).

In one embodiment, the communication unit 116 may also be configured to send and receive data to and from the transportation computing infrastructure 120. The transportation computing infrastructure 120 may be configured to include one or more externally hosted computing systems that may be owned, operated, and/or hosted by one or more transportation providers (e.g., shipping companies, freight haulers, cargo ship operators, and the like). In some embodiments, as the vehicles are being transported as part of the end-to-end supply chain process by one or more transportation providers, the one or more transportation providers may determine a location of respective transportation vehicles, vessels, and the like. The location may be provided based on the utilization of GPS technology that may be utilized by the respective transportation vehicles, vessels, and the like. For example, a real-time geo-positional location of one or more cargo ships that may be transporting one or more vehicles may be communicated to the transportation providers directly from GPS technology. Upon determining the geo-location of respective vessels, transportation vehicles and the like, such data may be provided to the transportation computing infrastructure 120.

In one embodiment, data that may be provided to the transportation computing infrastructure 120 may be communicated to the OEM server 102 as real-time vehicle logistics data and populated within the vehicle logistics data repository 112. The real-time vehicle logistics data may pertain to the locations of vessels, transportation vehicles, and/or other means of transportation that may be utilized to transport one or more one or more particular vehicles, one or more particular vehicle makes, one or more particular vehicle models, one or more particular vehicle configurations, one or more fleets of vehicles, one or more production lots of vehicles, vehicle parts associated with one or more vehicles, and the like.

In one embodiment, as the stakeholder(s) utilizes the one or more user interfaces of the vehicle SCL application 104 to query particular information that may pertain to the location of transportation vehicles, vessels, and the like, the vehicle SCL application 104 may thereby access the vehicle logistics data repository 112 and may further query the vehicle logistics data repository 112 to retrieve relevant vehicle logistics data that may pertain to the location of respective transportation vehicles, vessels, and the like. The vehicle SCL application 104 may be configured to thereby present the relevant vehicle logistics information that is derived from the relevant vehicle logistics data via the user interface(s) of the application 104 to provide the stakeholder(s) with a real-time location, status, and/or time based data points of one or more particular transportation vehicles, vessels, and the like as requested by the stakeholder(s).

### II. Exemplary User Interfaces of the Vehicle Supply Chain and Vehicle Logistics Information Presentation Application

As discussed above, the vehicle SCL application 104 may be configured to present one or more user interfaces to one or more stakeholders via respective computing systems that may be owned, operated, and/or utilized by the respective stakeholders. In particular, the one or more user interfaces may be presented in various graphical user interface layouts, manners, and with various types of graphics. The one or more user interfaces may include one or more types of user interface graphics that may include but may not be limited to, login prompts, user interface drop downs, user interface pop-up boxes, user interface pop-up menus, user interface input icons, user interface radio buttons, user interface spreadsheet layouts, user interface map layouts, user interface document layouts, user interface input text boxes, user interface application based input screens, user interface application based input layouts, electronic data messages, video graphics, image graphics, and the like. Some non-limiting examples of the user interfaces of the vehicle SCL application 104 will now be described.

In one embodiment, the user interfaces of the vehicle SCL application 104 may be presented with a login prompt that may be utilized for the stakeholder(s) to login to utilize the vehicle SCL application 104. As discussed above, the stakeholder data repository 114 stored upon the memory 108 of the OEM server 102 may include stakeholder profile data that may include stakeholder information and specific login and usage credentials that may be used to login to the vehicle SCL application 104 by one or more stakeholders to determine the real-time supply chain information and/or real-time logistics information that may be associated with one or more vehicles.

Accordingly, the stakeholder(s) may utilize the login prompt to input respective login and usage credentials associated with the stakeholder(s) that may be compared against login and usage credentials included within the stakeholder profile data to access one or more user interfaces of the application 104 to selectively receive vehicle supply chain data and/or vehicle logistics data as granted by the OEM, supply chain parties, and/or transportation providers. In some configurations, the login prompt may be accompanied with a forget username link and/or a password link that may allow the stakeholder(s) to retrieve a forgotten username and/or password from the respective stakeholder profile data and/or to create a new password that may be stored within the respective stakeholder profile data. In additional configurations, the vehicle SCL application 104 may allow the stakeholder(s) to answer personal identifier questions and may store respective answers within the stakeholder profile data. The answers to the personal identifier questions may allow the stakeholder(s) to thereby retrieve a forgotten username and/or password, or create a new password.

In an exemplary embodiment, upon authenticating the stakeholder(s), the vehicle SCL application 104 may query the stakeholder information to determine the level of privileges that may be assigned to the respective stakeholder by the OEM, supply chain parties, and/or transportation providers. As discussed above, the level of privileges may enable the respective stakeholder(s) to view one or more user interfaces that allow the stakeholder(s) to query particular vehicle supply chain information and/or vehicle logistics information. The level of privileges may also enable the respective stakeholder(s) to view one or more user interfaces that may present particular vehicle supply chain information, one or more user interfaces that may present particular vehicle logistics information, and/or one or more user interfaces that may present both vehicle supply chain information and vehicle logistics information.

Additionally, the level of privileges may enable the respective stakeholder(s) to view one or more categories of vehicle supply chain information and/or vehicle logistics information. Accordingly, based on the level of privileges that are retrieved from the respective stakeholder information included within the stakeholder data repository 114, the vehicle SCL application 104 may present one or more user interface links that may allow the stakeholder(s) to view one or user interfaces that may present vehicle supply chain information, vehicle logistics information, and/or a combination of vehicle supply chain information and vehicle logistics information that may be based on vehicle supply chain data and/or vehicle logistics data that may be retrieved by the vehicle SCL application 104.

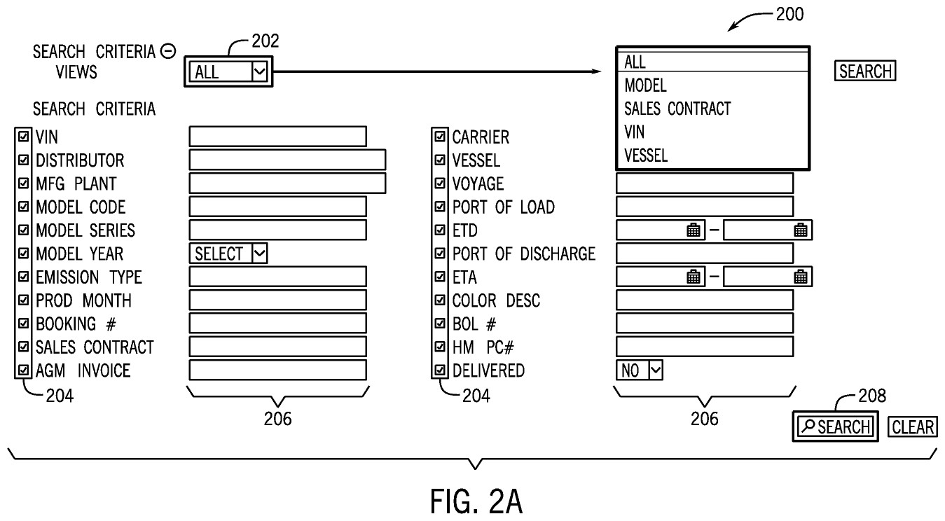

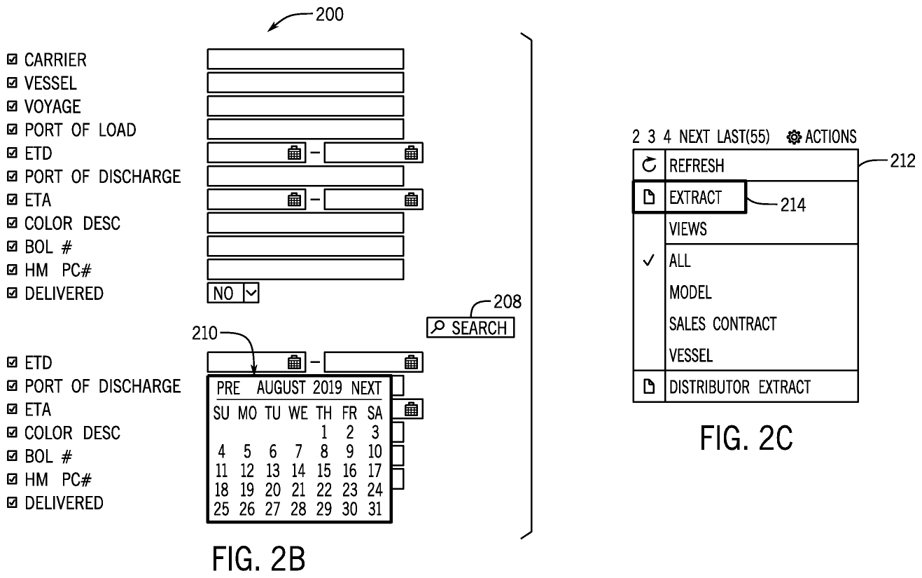

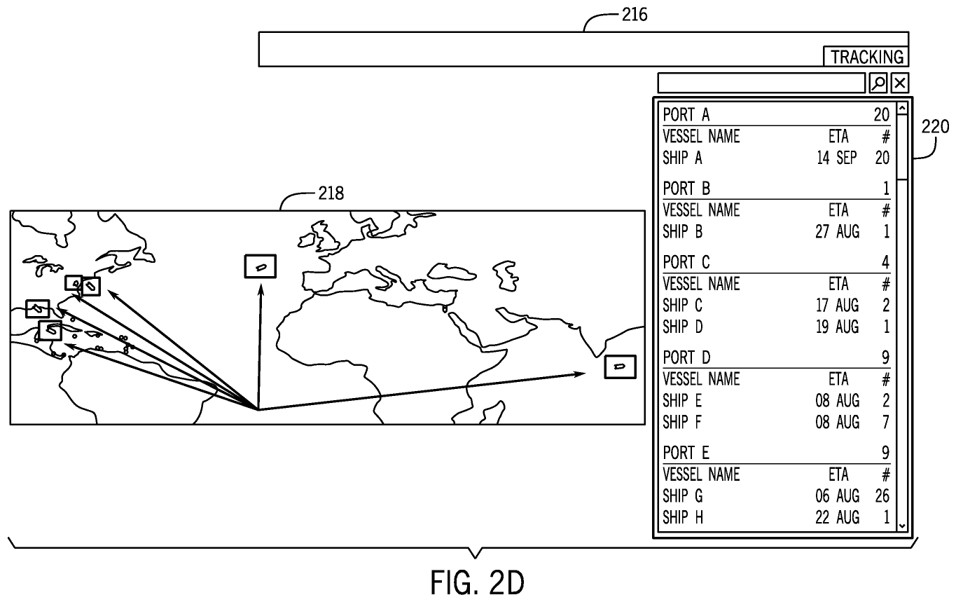

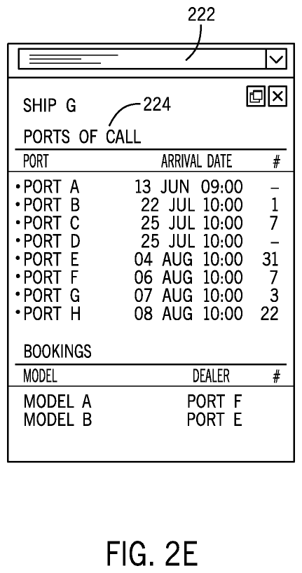

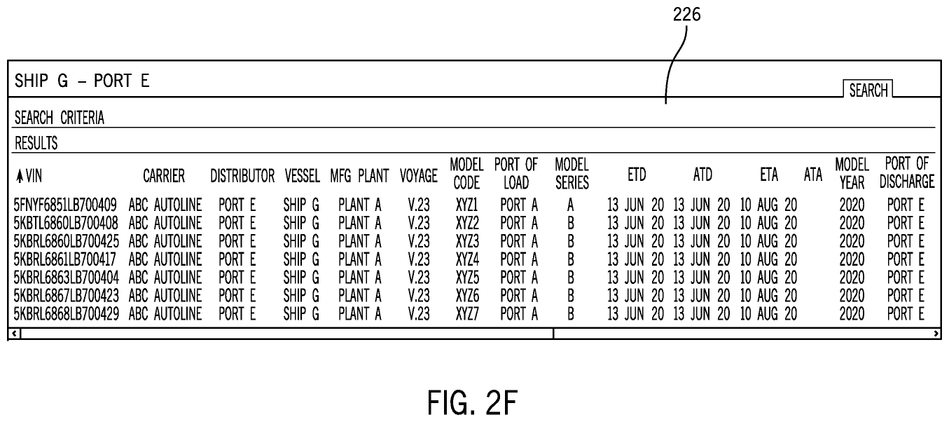

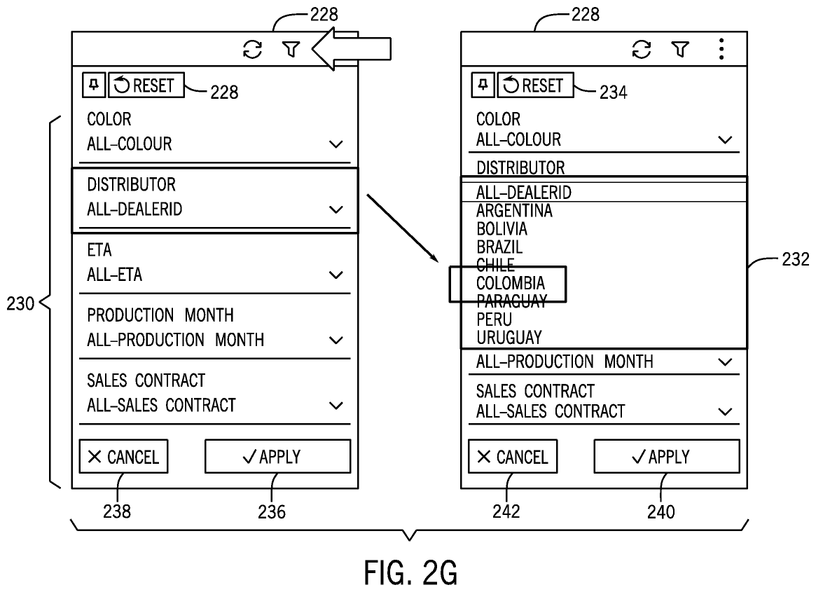

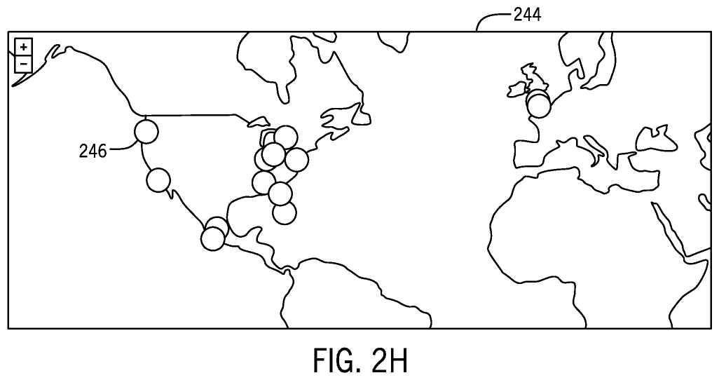

FIG. 2A includes an illustrative non-limiting example of a supply chain query user interface 200 that may allow the stakeholder(s) to select between various types of queries based on permissions that are granted to the stakeholder(s). As shown, in one example, the supply chain query user interface 200 may allow the stakeholder(s) to utilize a drop down menu 202 to select one or more types of query views that may specifically provide focus towards one or more types of queries. In particular, the drop down menu 202 may be associated with various search criteria identifiers (e.g., make, model, distributor, VIN, color, carrier, distributor, sales contact, etc.). Additionally, as shown, in one or more configurations, the supply chain query user interface 200 may include various check input user interface boxes 204 that may be checked or unchecked to provide respective queries associated with specific search criteria.

In one example, the supply chain query user interface 200 may allow the stakeholder(s) to provide a VIN query to determine real-time vehicle supply chain information that may be associated with a VIN(s) of a vehicle(s). In another example, based on privileges assigned to the stakeholder(s), the supply chain query user interface 200 may also allow the stakeholder(s) to determine logistics information that may affect supply chain information. For example, the supply chain query user interface 200 may allow the stakeholder(s) to track vessels that may allow the stakeholder(s) to determine real-time vehicle logistics data that may pertain to the real-time location, status, and/or time based data points of one or more particular transportation vehicles, vessels, and the like as requested by the stakeholder(s).

In one or more embodiments, the check input user interface boxes 204 may be associated with user interface input boxes/drop-down menus 206 that may allow the stakeholder(s) to provide specific data to be queried with respect to the respective search criteria. In some embodiments, as the stakeholder(s) starts to type data within one or more of the user interface input boxes/drop-down menus 206, the vehicle SCL application 104 may be configured to query the vehicle supply chain data repository 110 and/or the vehicle logistics data repository 112 to filter records within one or more of the repositories based on the typed data (e.g., partially typed data) to quickly provide query results to the stakeholder(s).

For example, if the stakeholder starts to type input a VIN of a vehicle with respect to VIN search criteria, records may be filtered out within the vehicle supply chain data repository 110 and/or the vehicle logistics data repository 112 that may include the partially typed VIN of the vehicle. Accordingly, the supply chain query user interface 200 may present information about one or more vehicles that may include a VIN with the characters of the partially typed VIN along with vehicle summaries (e.g., model details, trim details, production date, etc.) of the vehicles. Additionally, the supply chain query user interface 200 may also present the vehicle's current status, as well as the progress of the vehicle within the supply chain process (e.g., from the OEM plant to the destination port).

In one embodiment, by providing respective inputs to the user interface input boxes/drop-down menus 206 that may be associated with respective check input user interface boxes 204 pertaining to particular search criteria, the stakeholder(s) may be able to determine particular real-time vehicle supply chain information as desired based on inputting a search user interface input button 208 and inputting particular search query criteria to the supply chain query user interface 200. Such data may be utilized to query the vehicle supply chain data repository 110 and/or the vehicle logistics data repository 112 for relevant vehicle supply chain data and/or vehicle logistics data to present relevant search results. For example, such search results may provide a number of vehicles, models of vehicles, colors of vehicles, configuration of engine of vehicles, and the like that may be located at a particular port of entry.

In one or more embodiments, based on a query of manufacturing plants that may be made by the stakeholder(s) using the supply chain query user interface 200, the stakeholder(s) may be able to determine real-time supply chain information that may pertain to one or more manufacturing plants of the OEM by inputting query data (e.g., VIN, model, etc.) to determine one or more vehicles that may be manufactured by the plants. Accordingly, such data may be utilized to query the vehicle supply chain data repository 110 and/or the vehicle logistics data repository 112 and present relevant search results.

As shown in the non-limiting illustrative example of FIG. 2B, in some configurations, particular search criteria such as an estimated time of departure and/or an estimated time of arrival may be associated with a calendar user interface icon 210 that may allow the stakeholder(s) to determine real-time supply chain information that may pertain to one or more vehicles that may be released and/or may arrive at a particular location (e.g., port, dealership, etc.) during one or more timeframes. Upon inputting the timeframe(s) using the calendar user interface icon 210 and inputting the search user interface input button 208 on the supply chain query user interface 200, the vehicle SCL application 104 may be configured to query the vehicle supply chain data repository 110 and/or the vehicle logistics data repository 112 to obtain relevant data. The vehicle SCL application 104 may thereby present one or more user interfaces to provide the relevant records of vehicles within the selected timeframe(s). For example, one or more user interfaces may be presented with a list of VINs of vehicles that may be estimated to be released from a particular manufacturing plant based on respective search queries provided by the stakeholder(s) through the supply chain query user interface 200.

As shown in the non-limiting illustrative example of FIG. 2C, in some configurations, one or more user interfaces that present search query results, vehicle supply chain information and/or vehicle logistics information may include an action drop down menu 212. The action drop down menu 212 may allow the stakeholder(s) to perform particular actions based on privileges that may be assigned to the stakeholder(s). For instance, based on selection of an extract user interface menu item 214, the application 104 may allow the extraction of lists of data. For example, based on a particular search query, the one or more user interfaces may be presented with a user interface list of VINs of vehicles estimated to be released from a particular manufacturing plant during a particular timeframe. The one or more lists may be extracted to a document file format and/or a spreadsheet file format to be saved locally or forwarded by the stakeholder(s) though the input of the extract user interface menu item 214.

In some embodiments, the user interfaces of the vehicle SCL application 104 may be manipulated through touch input selection, mouse/touchpad input selection, and/or keystrokes (e.g., keyboard shortcuts). For example, one or more user interfaces that may present query results may be manipulated further by providing certain click inputs (e.g., right click, left click), keystroke inputs (e.g., keyboard shortcuts), and/or touch inputs (e.g., swiping inputs) to provide expanded search results, additional search results, alternate graphical formats of search results, and/or additional search query user interface pages. In some configurations, each of the user interfaces of the vehicle SCL application 104 may also include one or more types of custom user interface graphics that may indicate particular details that may be associated with one or more queries. For example, a time estimate of delivery of a vehicle may be indicated by a particular type of user interface graphic and an actual date of delivery of the vehicle may be indicated by an alternate type of user interface graphic.

With respect to vehicle logistics information, the user interfaces of the vehicle SCL application 104 may allow the stakeholder(s) to determine particular real-time vehicle logistics information as desired based on providing particular search query criteria through the user interface(s). The vehicle logistics information may be provided as the location of respective transportation vehicles, vessels, and the like. In one configuration, the vehicle SCL application 104 may query the vehicle logistics data repository 112 to determine the real-time geo-locations of respective transportation vehicles, vessels, and the like.

With reference to the non-limiting illustrative example of FIG. 2D, in an exemplary embodiment, upon the receipt of a search query for vehicle transportation tracking, based on the granting of specific permissions, the stakeholder(s) may be presented with a vehicle logistics query user interface 216. In one configuration, the vehicle logistics query user interface 216 may include a vehicle logistics tracking user interface map 218 and a vehicle transport list 220. As shown, the vehicle logistics tracking user interface map 218 may present one or more respective transportation vehicles and/or vessels that may be transporting one or more particular vehicles, one or more particular vehicle makes, one or more particular vehicle models, one or more particular vehicle configurations, one or more fleets of vehicles, one or more production lots of vehicles, vehicle parts associated with one or more vehicles, and the like, as selected to be presented by the stakeholder(s).

In some embodiments, the vehicle transport list 220 may be associated with one or more respective transportation vehicles and/or vessels that may be presented on the vehicle logistics tracking user interface map 218. In some configurations, the vehicle transport list 220 may include a name/description of one or more transportation vehicles and/or vessels, an expected voyage (e.g., expected travel path) of one or more transportation vehicles and/or vessels, a location/port of discharge of one or more transportation vehicles and/or vessels, a real-time region of one or more transportation vehicles and/or vessels, a country of origin of one or more transportation vehicles and/or vessels, a country of registration of one or more transportation vehicles and/or vessels, ports of call of one or more transportation vehicles and/or vessels, and the like. Accordingly, the vehicle transport list 220 may present additional details pertaining to one or more transportation vehicles and/or vessels that are presented on the vehicle logistics tracking user interface map 218.

In one or more embodiments, the vehicle logistics query user interface 216 may enable the stakeholder(s) to query one or more transportation vehicles and/or vessels to be represented on the vehicle logistics tracking user interface map 218 and/or the vehicle transport list 220. In one configuration, the vehicle logistics query user interface 216 may enable the stakeholder(s) to query one or more transportation vehicles and/or vessels based on a transportation vehicle identification/name, a vessel identification/name, a shipping company, an airline, a transportation company, a voyage identification (e.g., identification number, path, flight number, etc.) a port/airport of discharge, a port/airport of entry, a country of disembarkation, a country of operation, a location of discharge, a destination location, and the like. Accordingly, the vehicle SCL application 104 may query the vehicle supply chain data repository 110 and/or the vehicle logistics data repository 112 and may present relevant information pertaining to one or more transportation vehicles and/or vessels through the vehicle logistics tracking user interface map 218 and/or the vehicle transport list 220.

In some configurations, the vehicle logistics tracking user interface map 218 and/or the vehicle transport list 220 may include each transportation vehicle's and/or vessel's current forecasted route to a next port/airport/destination, real-time route traveled from a last port/airport/destination, and estimated time of arrival one or more future port/airport/destination. The vehicle logistics tracking user interface map 218 and/or the vehicle transport list 220 may additionally include a collapsible list of information (e.g., breakdown/summary of information) pertaining to one or more vehicles, one or more particular vehicle makes, one or more particular vehicle models, one or more particular vehicle configurations, one or more fleets of vehicles, one or more production lots of vehicles, vehicle parts associated with one or more vehicles, and the like that may be transported by one or more transportation vehicles and/or vessels. Such collapsible information may include, but may not be limited to, a breakdown of vehicle model trims, breakdown of stops/destinations of the vehicles, breakdown of quantities of vehicles in one or more fleets of vehicles, and the like.

In one or more embodiments, the vehicle logistics tracking user interface map 218 may also present ports of exit and ports of entry of one or more vessels. Each of the vessels (e.g., Ship A, Ship B, Ship C, etc.) listed within the vehicle transport list 220 may be represented by user interface input icons that may be inputted to view a port of call detail user interface that is associated with the particular selected vessel. In one or more embodiments, with reference to the non-limiting illustrative example of FIG. 2E, the port of call list user interface 222 may be configured to present a port of call user interface list 224 for one or more particular vessels selected from the vehicle transport list 220 of the vehicle logistics tracking user interface map 218.

Each port of call name presented upon the port of call user interface list 224 may be associated with timeframes that may be associated with the departure, transport, and/or expected arrival of the particular vessel at each particular port of call. In one configuration, each port of call presented upon the port of call user interface list 224 may be represented by a respective user interface input icon that may be inputted to present a port of call detail user interface that presents details pertaining to the particular port of call. Such details may provide data with respect to one or more particular vehicles that are entering and/or exiting one or more particular ports of call upon one or more particular vessels.

In one or more embodiments, with reference to the non-limiting illustrative example of FIG. 2F, the port of call detail user interface 226 may provide data associated with each of the particular vehicles that are entering and/or exiting one or more particular ports of call upon one or more particular vessels. As shown, the port of call detail user interface 226 may present, but may not be limited to a VIN of each of the vehicles that have entered/exited the port of call, the distributor of each of the vehicles that have entered/exited the port of call, the vessels that are transporting each of the vehicles that have entered/exited the port of call, the manufacturing plant of each of the vehicles that have entered/exited the port of call, a voyage code associated with each of the vehicles that have entered/exited the port of call, a model code/model number associated with each of the vehicles that have entered/exited the port of call, a port of load and a port of discharge of each of the vehicles that have entered/exited the port of call, a model series/model name of each of the vehicles that have entered/exited the port, a model year of each of the vehicles that have entered/exited the port, and timeframes associated with the departure, transport, and expected arrival (e.g., to another port, or final destination) of each of the vehicles that have entered/exited the port of call. Accordingly, detailed information associated with the vessels and ports of call may be provided based on inputs received upon the vehicle logistics tracking user interface map 218 and/or the vehicle transport list 220 of the vehicle logistics query user interface 216 (shown in FIG. 2D).

In one embodiment, user interface(s) of the vehicle SCL application 104 may enable the stakeholder(s) to provide a query with respect to both vehicle supply chain information and vehicle logistics information simultaneously. For example, the stakeholder(s) may be able to provide a query pertaining to one or more particular vehicles that may be transported using one or more of the transportation vehicles and/or vessels that are presented on the vehicle logistics tracking user interface map 218. The stakeholder(s) may be able to select (.e.g., input) a particular transportation vehicle and/or vessel to query the particular vehicles that may be transported using the respective transportation vehicles and/or vessels. Accordingly, the vehicle SCL application 104 may query the vehicle supply chain data repository 110 and/or the vehicle logistics data repository 112 and present relevant search results.

In one or more embodiments, with reference to the non-limiting illustrative example of FIG. 2G, the vehicle SCL application 104 may be configured to present a dashboard user interface 228 that may be configured to present transportation vehicles and/or vessels that may be actively being utilized in real-time within the end-to-end supply chain process. The dashboard user interface 228 may be configured to provide one or more screenshot views that may be associated with real-time vehicle supply chain information and/or real-time vehicle logistics information. As shown, the dashboard user interface 228 may additionally allow the stakeholder(s) to filter data in different charts.

In one example, data pertaining to vehicles that may be transported on a specific cargo ship may be filtered by color, distributor, estimated time of arrival to a dealer, production month, model, sales contact, and the like. As shown, based on the selection of one or more filter criteria 230 such as a distributor, the application 104 may present a user interface list 232 to provide a more specific query of the vehicle supply chain data repository 110 and/or the vehicle logistics data repository 112 to present the dashboard user interface 228 with query results. The dashboard user interface 228 may additionally include a reset user interface input icon 234 that may be inputted by the stakeholder(s) to reset the provided filter. Additionally, the dashboard user interface 228 may include an apply user interface input icon 236 that may be inputted to apply a filter and a cancel user interface input icon 238 to cancel the presentation of the dashboard user interface 228.

In one embodiment, upon the input of the apply user interface input icon 240 to filter vehicle supply chain data and/or vehicle logistics data, selected data may be queried per the filter on the vehicle supply chain data repository 110 and/or the vehicle logistics data repository 112. The dashboard user interface 228 may also present a cancel user interface input icon 242 to cancel the presentation of the dashboard user interface 228. Upon receiving an input upon the apply user interface input icon 240, the dashboard user interface 228 may present query results in the form of respective vehicle supply chain information and/or vehicle logistics information that may be manipulated and/or expanded to present more information through touch input selection, mouse/touchpad input selection, and/or keystrokes. For example, the dashboard user interface 228 may present query results in a list format that may be manipulated further by providing certain click inputs, keystroke inputs, and/or touch inputs to provide expanded search results, additional search results, alternate graphical formats of search results, and/or additional search query user interface pages.

As shown in the non-limiting illustrative example of FIG. 2H, the dashboard user interface 228 may be presented with a vehicle heat map 244. The vehicle heat map 244 may highlight certain locations, GPS coordinates, latitudes/longitudes, and the like on a user interface map. The vehicle heat map 244 may be configured to allow the stakeholder(s) to select particular locations (e.g., regions, states, cities, etc.) to determine real-time vehicle supply chain data and/or real-time vehicle logistics data that may be applicable to the particular location(s). For example, the stakeholder(s) may be able to select a user interface graphic 246 that may be presented upon a pacific northwest region to provide a query of one or more fleets of vehicles, one or more production lots of vehicles, vehicle parts associated with one or more vehicles, and the like that may be stored at distribution centers that are located at the pacific northwest region. Accordingly, the vehicle SCL application 104 may query the vehicle supply chain data repository 110 and/or the vehicle logistics data repository 112 and present relevant search results.

In one or more embodiments, the vehicle SCL application 104 may additionally present a log-out user interface prompt (not shown) and accompanying user interface(s) that may allow the stakeholder to log off from the utilizing the vehicle SCL application 104. In some configurations, the user interface(s) may be configured to determine a predetermined time of inactivity and may automatically log-off the stakeholder(s) when the predetermined time has surpassed. It is to be appreciated that additional contemplated data may be presented through the user interfaces of the vehicle SCL application 104 to allow the stakeholder(s) to determine vehicle supply chain information and vehicle logistics information associated with vehicles, vehicle parts, and/or other types of inventory that may be manufactured by the OEM, one or more subsidiaries of the OEM, and/or one or more entities that may be associated with the OEM.

### III. General Functionality and Methods Executed by the Vehicle Supply Chain and Vehicle Logistics Information Presentation Application

The general functionality of the vehicle SCL application 104 will now be discussed in more detail with respect to methods that may be executed by the application 104. In an exemplary embodiment, the vehicle SCL application 104 may be fully or partially executed by the processor 106 of the OEM server 102. Additionally, or alternatively, the vehicle SCL application 104 may be fully or partially executed by an externally hosted server infrastructure (not shown) that may owned and/or operated by the OEM, one or more subsidiaries of the OEM, one or more entities that may be granted administrative privileges by the OEM, supply chain parties, and/or transportation providers.

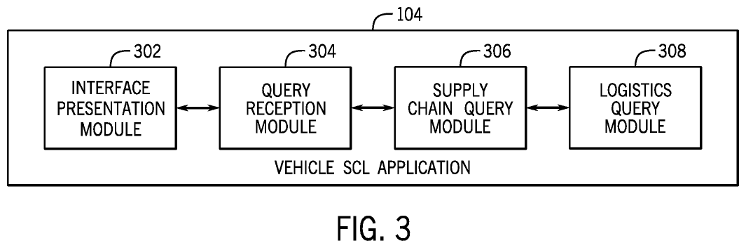

FIG. 3 is a schematic overview of a plurality of modules 302-308 of the vehicle SCL application 104 for providing vehicle supply chain and logistics information according to an exemplary embodiment of the present disclosure. In an exemplary embodiment, the plurality of modules 302-308 may include an interface presentation module 302, a query reception module 304, a supply chain query module 306, and a logistics query module 308. It is to be appreciated that the vehicle SCL application 104 may include one or more additional modules and/or sub-modules that are included in additional to or in lieu of the modules 302-308.

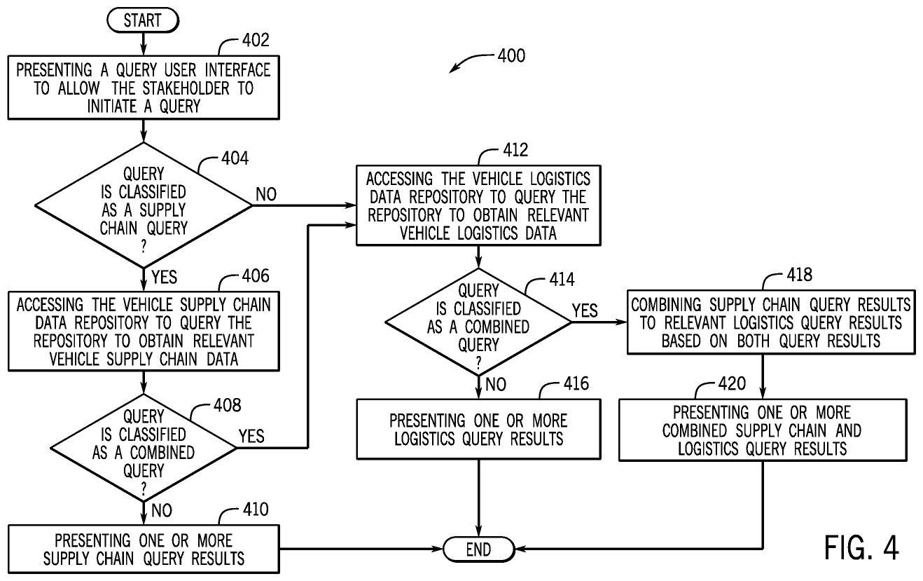

FIG. 4 is a process flow diagram of a method 400 for initiating a query to obtain vehicle supply chain data and/or vehicle logistics data according to an exemplary embodiment of the present disclosure. FIG. 4 will be described with reference to the components of FIG. 1, though it is to be appreciated that the method 400 of FIG. 4 may be used with additional and/or alternative system components. The method 400 may begin at block 402, wherein the method 400 may include presenting a query user interface to allow the stakeholder to initiate a query.

As discussed, the vehicle SCL application 104 may be configured to present one or more user interfaces to one or more stakeholders via respective computing systems that may be owned, operated, and/or utilized by the respective stakeholders. The stakeholder(s) may utilize one or more user interfaces of the vehicle SCL application 104 to query particular information that may pertain to vehicle supply chain data and/or vehicle logistics data.

In one embodiment, the interface presentation module 302 may be configured to present one or more user interfaces of the vehicle SCL application 104 based on a user input, a query, and/or a retrieval of vehicle supply chain data and/or vehicle logistics data that may be based on the query. In one embodiment, upon receiving a user input to execute and use the vehicle SCL application 104, the interface presentation module 302 may be configured to present the stakeholder(s) with a login user interface that includes a login prompt that may be utilized by the stakeholder(s) to login to utilize the vehicle SCL application 104.

In one embodiment, the stakeholder(s) may use the login prompt to input respective login credentials associated with the stakeholder(s) that may be compared against login and usage credentials included within the stakeholder profile data stored within the stakeholder data repository 114 to access one or more user interfaces of the application 104 to selectively view vehicle supply chain information and/or vehicle logistics information. In an exemplary embodiment, the interface presentation module 302 may authenticate the stakeholder(s) based on a receipt of valid user credentials through the login prompt. The interface presentation module 302 may be configured to thereby query the stakeholder information to determine a level of privileges that may be assigned to the stakeholder(s) by the OEM, supply chain parties, and/or transportation providers.

Based on the level of privileges that are retrieved from the respective stakeholder information included within the stakeholder data repository 114, the vehicle SCL application 104 may present one or more user interface links that may allow the stakeholder(s) to view one or more query user interfaces that may enable the stakeholder(s) to request a query of vehicle supply chain information, vehicle logistics information, and/or a combination of vehicle supply chain information and vehicle logistics information that may be based on vehicle supply chain data and/or vehicle logistics data. In one embodiment, the interface presentation module 302 may be configured to present a respective user interface of the vehicle SCL application 104 that may enable the stakeholder(s) to request a query of vehicle supply chain information and/or vehicle logistics information based on the input of one or more of the user interface links.

In another embodiment, the interface presentation module 302 may be configured to present a user interface that allows the stakeholder(s) to select a particular type of query user interface to be presented. For example, the stakeholder(s) may select from one of the aforementioned user interfaces that may include, but may not be limited to, the supply chain query user interface 200, the vehicle logistics query user interface 216, the dashboard user interface 228, and the vehicle heat map 244. Alternatively, the query user interface may be selectively or automatically be presented in one or more additional formats that may enable the stakeholder(s) to receive vehicle supply chain information and/or vehicle logistics information. In one embodiment, upon the presentation of the query user interface, the interface presentation module 302 may communicate with the query reception module 304 to receive the inputs of one or more queries that may be provided by the stakeholder(s) through the query user interface.

The method 400 may proceed to block 404, wherein the method 400 may include determining if the query is classified as a supply chain query. In an exemplary embodiment, the query reception module 304 may be configured to analyze the received inputs with respect to one or more queries that may be provided by the stakeholder(s) through the query user interface presented by the interface presentation module 302. In particular, the query reception module 304 may analyze data associated with one or more inputs to determine if the stakeholder(s) has inputted a query that pertains to the retrieval of some vehicle supply chain data or vehicle logistics data.

For example, if the supply chain query user interface 200 is utilized by the stakeholder(s) to input a query regarding a vehicle's current status, as well as the progress of the vehicle within the supply chain process (e.g., from the OEM manufacturing plant to the destination port), the query reception module 304 may analyze the query and classify the query as a vehicle supply chain query. Alternatively, if the vehicle logistics query user interface 216 is utilized by the stakeholder(s) to input a query regarding a vessel's current geo-location, the query reception module 304 may analyze the query and classify the query as a vehicle logistics query.

If it is determined that the query is classified as a supply chain query (at block 404), the method 400 may proceed to block 406, wherein the method 400 may include accessing the vehicle supply chain data repository 110 to query the repository 110 to obtain relevant vehicle supply chain data. In an exemplary embodiment, upon classifying the query provided by the stakeholder(s) as a supply chain query, the query reception module 304 may communicate respective data pertaining to the classification and the received query to the supply chain query module 306 of the vehicle SCL application 104.

In one embodiment, the supply chain query module 306 may be configured to analyze the data pertaining to the classification and the received query to determine one or more vehicle supply chain data points that are to be provided as search operators to the vehicle supply chain data repository 110 in order to retrieve relevant vehicle supply chain data that may satisfy the query provided by the stakeholder(s). Upon determining one or more vehicle supply chain data points, the supply chain query module 306 may be configured to communicate with the vehicle supply chain data repository 110 to query the repository 110 for relevant vehicle supply chain data. The supply chain query module 306 may thereby retrieve the relevant vehicle supply chain data to fulfill the query. In one or more embodiments, the supply chain query module 306 may be configured to access the memory 108 and store the relevant vehicle supply chain data to be accessed by the interface presentation module 302 to be presented as relevant vehicle supply chain information.

The method 400 may proceed to block 408, wherein the method 400 may include determining if the query is classified as a combined query. In one embodiment, the query reception module 304 may analyze data associated with one or more inputs to determine if the stakeholder(s) has inputted a query that pertains to the retrieval of both vehicle supply chain data and vehicle logistics data. The query reception module 304 may thereby communicate the type of query to the supply chain query module 306.

The supply chain query module 306 may thereby determine if the query is classified as a combined query. For example, if the dashboard user interface 228 is utilized by the stakeholder(s) to input a query regarding a geo-location of a vessel that may be transporting a specific model of vehicles, the query reception module 304 may analyze the query and classify the query as a combined query. In one configuration, upon classifying the query has a combined query, the query reception module 304 may access the memory 108 of the OEM server 102 and store a combined query data flag on the memory 108. As discussed below, the memory 108 may be accessed by the logistics query module 308 of the vehicle SCL application 104 to determine if the combined query data flag is stored or not stored upon the memory 108.

If it is determined that the query is not classified as a combined query (at block 408), and is therefore classified as the vehicle supply chain query, the method 400 may proceed to block 410, wherein the method 400 may include presenting one or more supply chain query results. As discussed above, upon accessing the vehicle supply chain data repository 110 to retrieve data per the supply chain query of the stakeholder(s), the supply chain query module 306 may be configured to access the memory 108 and store the relevant vehicle supply chain data to be accessed by the interface presentation module 302. The interface presentation module 302 may be configured to retrieve the stored relevant vehicle supply chain data and may present one or more user interfaces of the vehicle SCL application 104 to present the supply chain query results in the form of vehicle supply chain information. The stakeholder(s) may thereby receive the vehicle supply chain information to fulfill the supply chain query inputted to the respective query user interface of the vehicle SCL application 104.

Referring again to block 404 and block 408, if it is determined that the query is not classified as a supply chain query (at block 404) or it is determined that the query is classified as a combined query (at block 408), the method 400 may proceed to block 412, wherein the method 400 may include accessing the vehicle logistics data repository 112 to query the repository 112 to obtain relevant vehicle logistics data. As discussed above, the query reception module 304 may be configured to analyze the received inputs with respect to one or more queries that may be provided by the stakeholder(s) through one or more of the user interfaces presented by the interface presentation module 302. In particular, the query reception module 304 may analyze data associated with one or more inputs to determine if the stakeholder(s) has inputted a query that pertains to the retrieval of some vehicle logistics data. Accordingly, if it is determined that the query is classified as a vehicle logistics data query, the query reception module 304 may communicate respective data pertaining to the classification to the logistics query module 308 of the vehicle SCL application 104.

In one embodiment, the logistics query module 308 may be configured to analyze the data pertaining to the classification and the received query to determine one or more vehicle logistics data points that are to be provided as search operators to the vehicle logistics data repository 112 in order to retrieve relevant vehicle logistics data that may satisfy the query provided by the stakeholder(s). Upon determining one or more vehicle logistics data points, the logistics query module 308 may be configured to communicate with the vehicle logistics data repository 112 to query the repository 112 for relevant vehicle logistics data. The logistics query module 308 may thereby retrieve the relevant vehicle logistics data to fulfill the query. In one or more embodiments, the logistics query module 308 may be configured to access the memory 108 and store the relevant vehicle logistics data to be accessed by the interface presentation module 302 to be presented as relevant vehicle logistics information.

The method 400 may proceed to block 414, wherein the method 400 may include determining if the query is classified as a combined query. As discussed above (with respect to block 408), upon classifying the query has a combined query, the query reception module 304 may access the memory 108 of the OEM server 102 and store a combined query data flag on the memory 108.

In one embodiment, upon the retrieval of relevant vehicle logistics data from the vehicle logistics data repository 112, the logistics query module 308 may be configured to access the memory 108 of the OEM server 102. The logistics query module 308 may be further configured to query the memory to determine if the combined query data flag was previously stored on the memory 108 by the query reception module 304 if it was determined (at block 408) that the query is classified as a combined query or if the combined query data flag was not previously stored on the memory 108 by the query reception module 304 if it was not determined (at block 408) that the query is not classified as the combined query.

Accordingly, based on determining the existence or non-existence of the combined query data flag, the logistics query module 308 may thereby determine if the query is classified as a combined query or not classified as a combined query. In one configuration, if the query is classified as a combined query, based on the existence of the combined query data flag, the logistics query module 308 may retrieve the combined query data flag. The combined query data flag that pertains to the particular combined query provided by the stakeholder(s) may thereby be removed (e.g., deleted) from the memory 108.

If it is determined that the query is not classified as a combined query (at block 414) and is therefore classified as the vehicle logistics query, the method 400 may proceed to block 416, wherein the method 400 may include presenting one or more logistics query results. As discussed above, upon accessing the vehicle logistics data repository 112 to retrieve data per the logistics query of the stakeholder(s), the logistics query module 308 may be configured to access the memory 108 and store the relevant logistics data to be accessed by the interface presentation module 302. The interface presentation module 302 may be configured to retrieve the stored relevant vehicle logistics data and may present one or more user interfaces of the vehicle SCL application 104 to present the logistics query results in the form of vehicle logistics information. The stakeholder(s) may thereby receive the vehicle logistics information to fulfill the vehicle logistics query inputted to the respective query user interface of the vehicle SCL application 104.

If it is determined that the query is classified as a combined query (at block 414), the method 400 may proceed to block 418, wherein the method 400 may include combining supply chain query results to relevant logistics query results based on both query results. In an exemplary embodiment, upon determining that the query is classified as combined query (at block 414), the logistics query module 308 may communicate respective data to the interface presentation module 302. The interface presentation module 302 may be configured to communicate with the query reception module 304 to determine one or more vehicle supply chain logistics data points and vehicle logistics data points that may be inputted to through the query user interface by the stakeholder(s). The interface presentation module 302 may accordingly communicate with the supply chain query module 306 and the logistics query module 308 to respectively query the vehicle supply chain data repository 110 and the vehicle logistics data repository 112 and retrieve respective vehicle supply chain data and vehicle logistics data to fulfil the respective queries.

Upon retrieval of the respective vehicle supply chain data and vehicle logistics data, the interface presentation module 302 may be configured to analyze the vehicle supply chain data and vehicle logistics data to determine one or more data points that may indicate that both sets of data are to be paired. The one or more data points that may indicate that both sets of data are to be paired may include data consistencies that may be present within both of the vehicle supply chain data and vehicle logistics data. Such data consistencies may include, but may not be limited to, a VIN, a make, a model, a body style, a configuration of the engine, a color, a distributor, a sales contact, a production date, a manufacturing facility, a shipping company, an airline, a vessel, a flight number, and the like that may be included within both sets of data. In one embodiment, upon determining such data consistencies, the interface presentation module 302 may be configured to combine the one or more data points that may indicate that both sets of data are to be paired to thereby process one or more combined sets of vehicle supply chain logistics data.

The method 400 may proceed to block 420, wherein the method 400 may include presenting one or more combined supply chain and logistics query results. In an exemplary embodiment, upon processing the one or more combined sets of vehicle supply chain logistics data, the interface presentation module 302 may be configured to present one or more user interfaces of the vehicle SCL application 104 to provide the one or more combined sets of vehicle supply chain logistics data.

The stakeholder(s) may thereby receive a combination of vehicle supply chain information and vehicle logistics information to fulfill the combined supply chain and logistics query inputted to the respective query user interface of the vehicle SCL application 104. For example, if the dashboard user interface 228 is utilized by the stakeholder(s) to input a query regarding a geo-location of an aircraft that may be transporting a specific vehicle with a specific VIN, the interface presentation module 302 may be configured to present a combination of vehicle supply chain information and vehicle logistics information that pertains to the location and associated information (e.g., flight number, expected travel path) of the particular aircraft that is transporting the specific vehicle and associated information (e.g., make, model, production date) to fulfill the combined supply chain and logistics query.

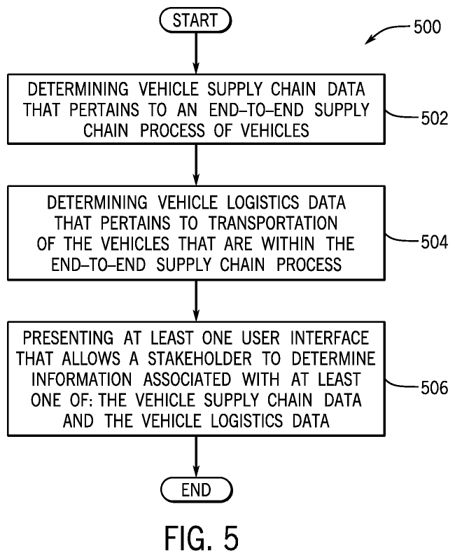

FIG. 5 is a process flow diagram of a method 500 for providing vehicle supply chain and logistics information according to an exemplary embodiment of the present disclosure. FIG. 5 will be described with reference to the components of FIG. 1, though it is to be appreciated that the method 500 of FIG. 5 may be used with additional and/or alternative system components. The method 500 may begin at block 502, wherein the method 500 may include determining vehicle supply chain data that pertains to an end-to-end supply chain process of vehicles.

The method 500 may proceed to block 504, wherein the method 500 may include determining vehicle logistics data that pertains to transportation of the vehicles that are within the end-to-end supply chain process. The method 500 may proceed to block 506, wherein the method 500 may include presenting at least one user interface that allows a stakeholder to determine information associated with at least one of: the vehicle supply chain data and the vehicle logistics data.

The embodiments discussed herein may also be described and implemented in the context of non-transitory computer-readable storage medium storing computer-executable instructions. Non-transitory computer-readable storage media includes computer storage media and communication media. For example, flash memory drives, digital versatile discs (DVDs), compact discs (CDs), floppy disks, and tape cassettes. Non-transitory computer-readable storage media may include volatile and nonvolatile, removable and non-removable media implemented sin any method or technology for storage of information such as computer readable instructions, data structures, modules or other data. Non-transitory computer readable storage media excludes transitory and propagated data signals.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for providing vehicle supply chain and logistics information, comprising:
determining vehicle supply chain data that pertains to an end-to-end supply chain process of vehicles;
determining vehicle logistics data that pertains to transportation of the vehicles that are within the end-to-end supply chain process; and
presenting at least one user interface that allows a stakeholder to determine information associated with at least one of: the vehicle supply chain data and the vehicle logistics data.

2. The computer-implemented method of claim 1, further including presenting a query user interface to allow the stakeholder to initiate a query for the vehicle supply chain data, the vehicle logistics data, or a combination of the vehicle supply chain data and the vehicle logistics data.

3. The computer-implemented method of claim 2, further including analyzing the query provided by the stakeholder through the query user interface to determine if the query is classified as a query for the vehicle supply chain data, a query for the vehicle logistics data, or a query for the combination of the vehicle supply chain data and the vehicle logistics data.

4. The computer-implemented method of claim 3, wherein the vehicle supply chain data is provided by at least one supply chain entity that is involved in the end-to-end supply chain process, wherein the supply chain data includes end-to-end supply chain information associated with at least one of: a location, a status, an inventory, and a timing of the vehicles.

5. The computer-implemented method of claim 3, wherein determining the vehicle supply chain data includes determining that the query is classified as the query for the vehicle supply chain data and accessing a vehicle supply chain data repository to obtain the vehicle supply chain data to fulfill the query.

6. The computer-implemented method of claim 3, wherein the vehicle logistics data is provided by at least one transportation entity that is involved with the transportation of the vehicles that are within the end-to-end supply chain process, wherein the vehicle logistics data includes a location of at least one of: a vessel or a transportation vehicle that is used to transport the vehicles.

7. The computer-implemented method of claim 3, wherein determining the vehicle logistics data includes determining that the query is classified as the query for the vehicle logistics data and accessing a vehicle logistics data repository to obtain the vehicle logistics data to fulfill the query.

8. The computer-implemented method of claim 3, further including combining supply chain query results to relevant logistics query results when it is determined that the query is classified as the query for the combination of the vehicle supply chain data and the vehicle logistics data, wherein the vehicle supply chain data and the vehicle logistics data is analyzed to determine data consistencies between the vehicle supply chain data and the vehicle logistics data that indicate that both sets of data are to be paired.

9. The computer-implemented method of claim 1, wherein presenting the at least one user interface includes presenting at least one of: a supply chain query user interface and a vehicle logistics query user interface that presents at least one of: vehicle supply chain information and vehicle logistics information that are derived from the vehicle supply chain data and the vehicle logistics data.

10. A system for providing vehicle supply chain and logistics information, comprising:
a memory storing instructions when executed by a processor cause the processor to:
determine vehicle supply chain data that pertains to an end-to-end supply chain process of vehicles;
determine vehicle logistics data that pertains to transportation of the vehicles that are within the end-to-end supply chain process; and
present at least one user interface that allows a stakeholder to determine information associated with at least one of: the vehicle supply chain data and the vehicle logistics data.

11. The system of claim 10, further including presenting a query user interface to allow the stakeholder to initiate a query for the vehicle supply chain data, the vehicle logistics data, or a combination of the vehicle supply chain data and the vehicle logistics data.

12. The system of claim 11, further including analyzing the query provided by the stakeholder through the query user interface to determine if the query is classified as a query for the vehicle supply chain data, a query for the vehicle logistics data, or a query for the combination of the vehicle supply chain data and the vehicle logistics data.

13. The system of claim 12, wherein the vehicle supply chain data is provided by at least one supply chain entity that is involved in the end-to-end supply chain process, wherein the supply chain data includes end-to-end supply chain information associated with at least one of: a location, a status, an inventory, and a timing of the vehicles.

14. The system of claim 12, wherein determining the vehicle supply chain data includes determining that the query is classified as the query for the vehicle supply chain data and accessing a vehicle supply chain data repository to obtain the vehicle supply chain data to fulfill the query.

15. The system of claim 12, wherein the vehicle logistics data is provided by at least one transportation entity that is involved with the transportation of the vehicles that are within the end-to-end supply chain process, wherein the vehicle logistics data includes a location of at least one of: a vessel or a transportation vehicle that is used to transport the vehicles.

16. The system of claim 12, wherein determining the vehicle logistics data includes determining that the query is classified as the query for the vehicle logistics data and accessing a vehicle logistics data repository to obtain the vehicle logistics data to fulfill the query.

17. The system of claim 12, further including combining supply chain query results to relevant logistics query results when it is determined that the query is classified as the query for the combination of the vehicle supply chain data and the vehicle logistics data, wherein the vehicle supply chain data and the vehicle logistics data is analyzed to determine data consistencies between the vehicle supply chain data and the vehicle logistics data that indicate that both sets of data are to be paired.

18. The system of claim 10, wherein presenting the at least one user interface includes presenting at least one of: a supply chain query user interface and a vehicle logistics query user interface that presents at least one of: vehicle supply chain information and vehicle logistics information that are derived from the vehicle supply chain data and the vehicle logistics data.

19. A non-transitory computer readable storage medium storing instructions that when executed by a computer, which includes a processor perform a method, the method comprising:
determining vehicle supply chain data that pertains to an end-to-end supply chain process of vehicles;
determining vehicle logistics data that pertains to transportation of the vehicles that are within the end-to-end supply chain process; and
presenting at least one user interface that allows a stakeholder to determine information associated with at least one of: the vehicle supply chain data and the vehicle logistics data.

20. The non-transitory computer readable storage medium of claim 19, wherein presenting the at least one user interface includes presenting at least one of: a supply chain query user interface and a vehicle logistics query user interface that presents at least one of: vehicle supply chain information and vehicle logistics information that are derived from the vehicle supply chain data and the vehicle logistics data.
